(19) United States
(12) Patent Application Publication
(10) Pub. No.: US 2026/0322022 A1
(43) Pub. Date: Oct. 15, 2026

(54) Electrical Terminal

(71) Applicant: Aptiv Technologies AG, Schaffhausen (CH)

(72) Inventors: John Morello, Warren, OH (US); James Rainey, Warren, OH (US)

(21) Appl. No.: 19/176,543

(22) Filed: Apr. 11, 2025

(51) Int. Cl. H01R 13/11; H01R 25/16

(52) U.S. Cl. CPC H01R 13/11; H01R 25/161

(57) ABSTRACT

A terminal includes a first contact region, a first connection region, and a first compliant region. The first contact region includes a first flexible arm. The first compliant region is disposed between the first contact region and the first connection region. The first compliant region defines a first aperture.

### FIELD

The present disclosure relates to a terminal for an electrical connector and more particularly to a direct contact compliant bus terminal.

### BACKGROUND

Modern vehicles (e.g., automobiles) rely on electrical wiring and electrical connections to facilitate the transmission of electricity within, and between various components of, the vehicle. Electrical terminals play an important role in ensuring the integrity of these electrical connections and the reliability and performance of the vehicle. For example, when two electrical connectors connect to one another, the terminals within each connector may engage one another to ensure a secure electrical connection. In high electrical current applications, the thickness of a terminal may be increased to ensure effective transmission of current without an undesirable rise in temperature. This increase in thickness can create a corresponding increase in the rigidity of the terminal. In such applications, the force required to create engagement between terminals may be so large that a rigid terminal disengages from a corresponding terminal within the electrical connector causing a disruption in the transmission of electricity through the electrical connector. While known terminals and systems and methods for improving electrical connections have proven acceptable for their intended purposes, there remains a continuous need for improvement in the relevant art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a terminal. The terminal includes a first contact region, a first connection region, and a first compliant region. The first contact region includes a first flexible arm. The first compliant region is disposed between the first contact region and the first connection region. The first compliant region defines a first aperture.

One aspect of the disclosure provides a busbar. The busbar includes a first contact region, a first connection region, and a first compliant region. The first compliant region is disposed between the first contact region and the first connection region. The first compliant region defines a first aperture configured to allow the first contact region to flex relative to the first connection region.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an electrical connector according to the principles of the present disclosure.

FIG. 2 is a first cross-sectional view of the electrical connector of FIG. 1 taken through the line 2-2.

FIG. 3 is a second cross-sectional view of the electrical connector of FIG. 1.

FIG. 4 is perspective view of a terminal according to the principles of the present disclosure.

FIG. 5 is an exploded view of the terminal of FIG. 4.

FIG. 6 is a cross-sectional perspective view of a contact region of the terminal of FIG. 4.

FIG. 7 is a cross-sectional perspective view of a compliant region of the terminal of FIG. 4.

FIG. 8 is a perspective view of another terminal according to the principles of the present disclosure.

FIG. 9 is a cross-sectional view of the terminal of FIG. 8 taken through the line 10-10.

FIG. 10 is an exploded view of the terminal of FIG. 8.

FIG. 11 is a perspective view of another terminal according to the principles of the present disclosure.

FIG. 12 is a cross-sectional view of the terminal of FIG. 11 taken through the line 12-12.

FIG. 13 is an exploded view of the terminal of FIG. 11.

FIG. 14 is a perspective view of another terminal according to the principles of the present disclosure.

FIG. 15 is an exploded view of the terminal of FIG. 14.

In the drawings, reference numbers may be reused to identify similar and/or identical elements.

### DETAILED DESCRIPTION

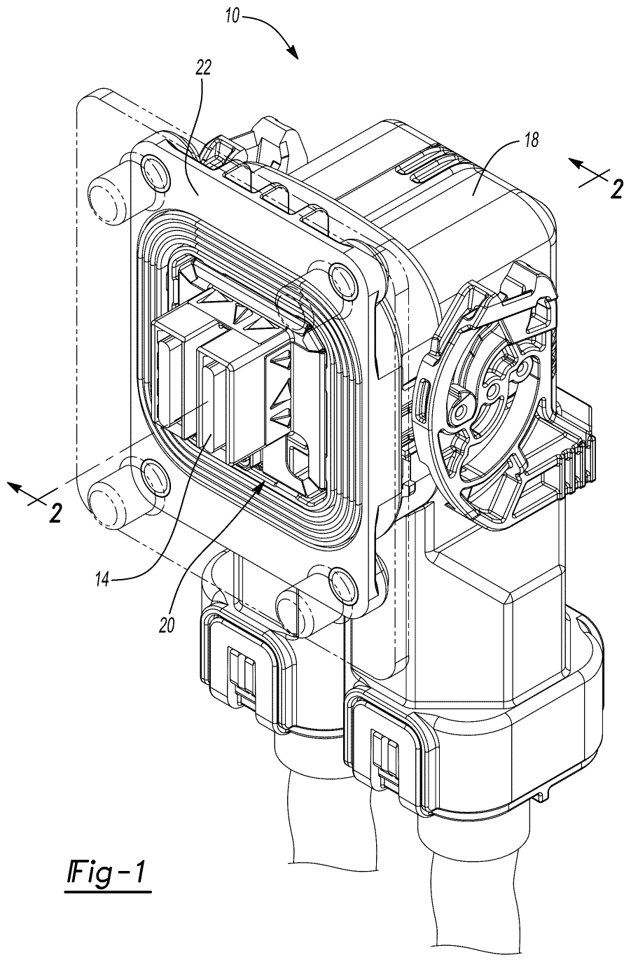

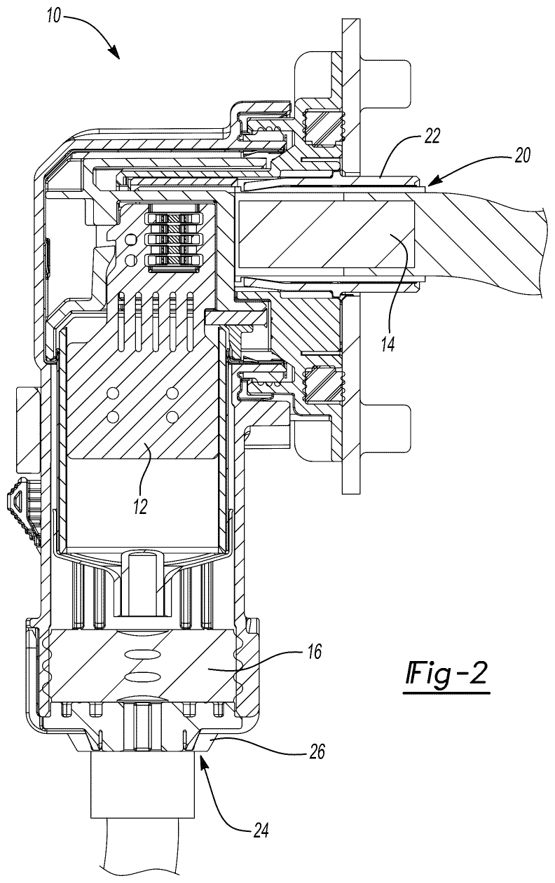

With reference to FIGS. 1-3, a connector 10 (e.g., an electrical connector) is shown. As will be explained in more detail below, the connector 10 may be used in a vehicle (e.g., an automobile, not shown) to facilitate the transmission of electricity between various components (e.g., batteries, lights, etc.) of the vehicle. For example, the connector 10 may be a male or female connector detachably couplable to a mating connector (e.g., a male or female connector, not shown) such that, during operation of the vehicle, electricity is transmitted through the connector 10 and to various electronic components within the vehicle.

The connector 10 may include a terminal 12, a first electrical contact 14, a second electrical contact 16, and a main body portion 18. The terminal 12 may be referred to herein as a busbar 12. The terminal 12, the first electrical contact 14, and the second electrical contact 16 may be disposed within the main body portion 18 of the connector 10. The main body portion 18 may include a first opening 20 formed in a first end 22 of the main body portion 18 and a second opening 24 formed in a second end 26 of the main body portion 18. The first electrical contact 14 may extend through the first opening 20. The second electrical contact 16 may extend through the second opening 24. The terminal 12 may be disposed between the first electrical contact 14 and the second electrical contact 16. In some implementations, the terminal 12 connects (e.g., electrically connects) the first electrical contact 14 to the second electrical contact 16.

In some implementations, during mating of the connector 10 with a corresponding connector, the corresponding connector may apply a force on the first electrical contact 14 and/or the second electrical contact 16. As a result, the first electrical contact 14 and/or the second electrical contact 16 may apply a force upon the terminal 12. As will be explained in more detail below, the terminal 12 may be flexible (e.g., bendable), such that the force applied by the first electrical contact 14 and/or the second electrical contact 16 does not disengage the terminal 12 from the other of the first electrical contact 14 and/or the second electrical contact 16.

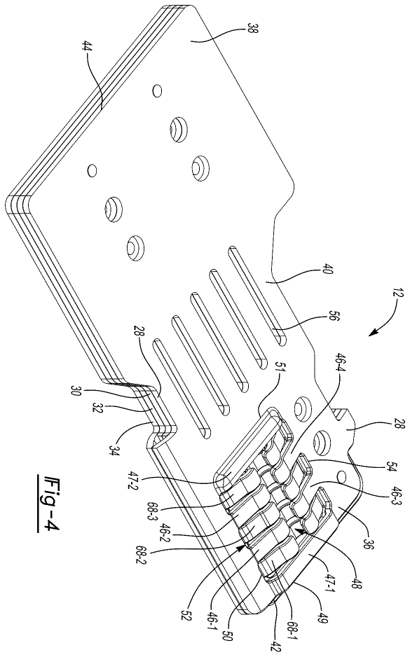

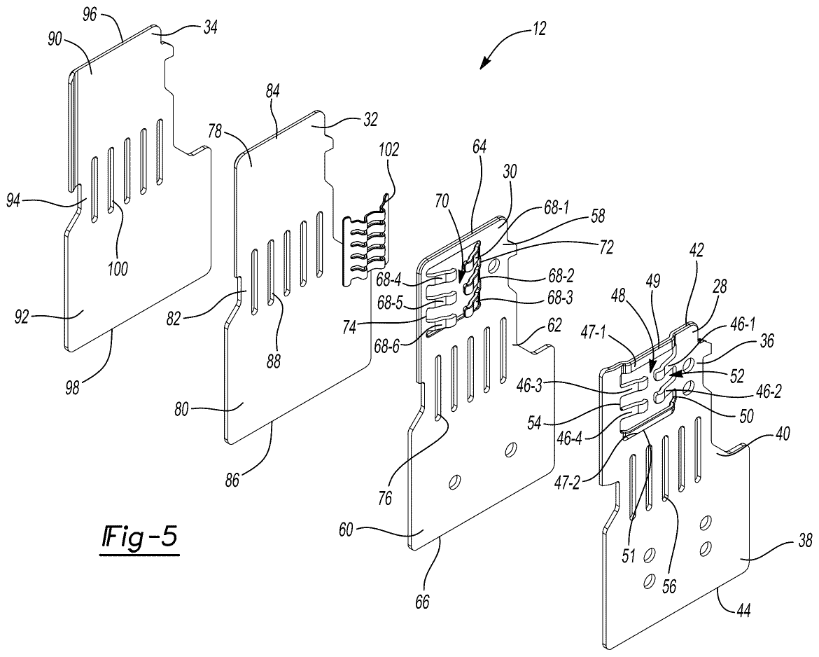

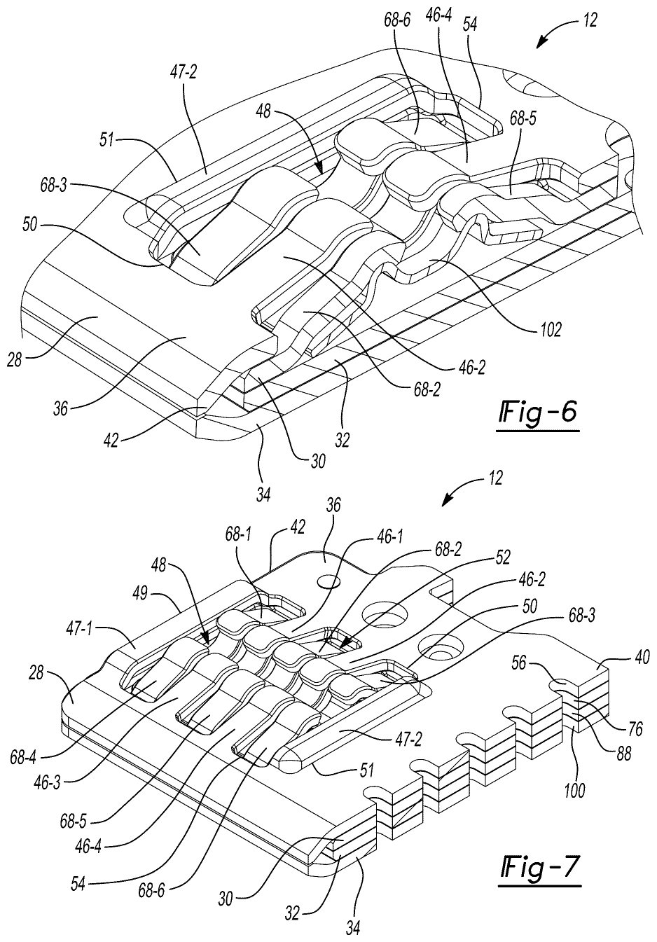

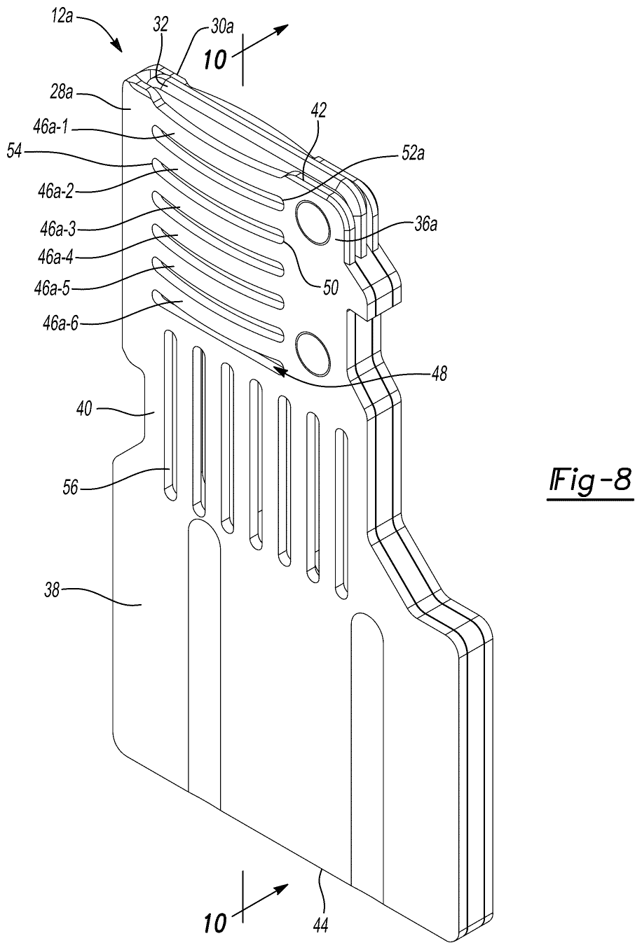

Referring now to FIGS. 4-7, the terminal 12 may be formed from one or more plates stacked upon one another. For example, the terminal 12 may be formed from two, three, four, or five plates stacked upon one another. The plates may be formed from any suitable material (e.g., a stamped sheet metal). The one or more plates may be connected to one another by various methods. In some implementations, the one or more plates are welded to one another.

In some implementations, the terminal 12 includes a first plate 28, a second plate 30, a third plate 32, and a fourth plate 34. The second plate 30 may be disposed between the first plate 28 and the third plate 32. The third plate 32 may be disposed between the second plate 30 and the fourth plate 34.

The first plate 28 may include a first contact region 36, a first connection region 38, and a first compliant region 40. The first compliant region 40 may be disposed between the first contact region 36 and the first connection region 38. In this regard, the first contact region 36 may be disposed proximate a first end 42 of the first plate 28 and the first connection region 38 may be disposed proximate a second end 44 of the first plate 28.

The first contact region 36 may include one or more flexible arms 46, one or more rigid contacts 47, and an opening 48. The one or more flexible arms 46 may extend from one or more edges of the opening 48 towards a center of the opening 48. For example, the one or more flexible arms 46 may include a first flexible arm 46-1 and a second flexible arm 46-2 extending from a first edge 50 of the opening 48. The first flexible arm 46-1 and the second flexible arm 46-2 may at least partially define a gap 52 therebetween. In some implementations, the first contact region 36 further includes a third flexible arm 46-3 and a fourth flexible arm 46-4 extending from a second edge 54 of the opening 48. The third flexible arm 46-3 may extend towards the first flexible arm 46-1 and the fourth flexible arm 46-4 may extend towards the second flexible arm 46-2. The second edge 54 may be opposite the first edge 50. The one or more flexible arms 46 may flex (e.g., bend) upon contacting a corresponding terminal of a corresponding electrical connector (not shown) and/or the first electrical contact 14.

The one or more rigid contacts 47 may engage a corresponding terminal of a corresponding electrical connector (not shown) and/or the first electrical contact 14. The one or more rigid contacts 47 may include a first rigid contact 47-1 and a second rigid contact 47-2. The first rigid contact 47-1 may extend from a third side 49 of the opening 48 and the second rigid contact 47-2 may extend from a fourth side 51 of the opening 48.

The first connection region 38 may engage a corresponding terminal of a corresponding electrical connector (not shown) and/or the second electrical contact 16.

The first compliant region 40 may include a first set of apertures 56. One or more apertures of the first set of apertures 56 may extend through the first plate 28. In some implementations, the first set of apertures 56 includes five apertures 56. Each aperture of the first set of apertures 56 may be stadium-shaped (e.g., a rectangle with semicircles at a pair of opposite sides). The apertures 56 could also be any other shape within the scope of the present disclosure. In some implementations, the first set of apertures 56 is equally-spaced across the first compliant region 40.

The first set of apertures 56 may allow the first contact region 36 to flex (e.g., bend) relative to the first connection region 38. In this regard, the first set of apertures 56 may reduce the stiffness of the first compliant region 40 relative to the other portions of the terminal 12 (e.g., the first contact region 36, the first connection region 38, etc.). In some implementations, the stiffness of the first compliant region 40 is less than the stiffness of a corresponding terminal (not shown) that the terminal 12 mates with.

The second plate 30 may include a second contact region 58, a second connection region 60, and a second compliant region 62. The second compliant region 62 may be disposed between the second contact region 58 and the second connection region 60. In this regard, the second contact region 58 may be disposed proximate a first end 64 of the second plate 30 and the second connection region 60 may be disposed proximate a second end 66 of the second plate 30.

The second contact region 58 may include one or more flexible arms 68 and an opening 70. The one or more flexible arms 68 may extend from one or more edges of the opening 70 towards a center of the opening 70. For example, the one or more flexible arms 68 may include a first flexible arm 68-1, a second flexible arm 68-2, and a third flexible arm 68-3 extending from a first edge 72 of the opening 70. When the terminal 12 is assembled, the first flexible arm 68-1, the second flexible arm 68-2, the third flexible arm 68-3, the first flexible arm 46-1, and the second flexible arm 46-2 may be arranged in an alternating fashion. In this regard, the second flexible arm 68-2 may be disposed in the gap 52 between the first flexible arm 46-1 and the second flexible arm 46-2.

In some implementations, the second contact region 58 further includes a fourth flexible arm 68-4, a fifth flexible arm 68-5, and a sixth flexible arm 68-6 extending from a second edge 74 of the opening 70. The second edge 74 may be opposite the first edge 72. The one or more flexible arms 68 may flex (e.g., bend) upon coming into contact with a corresponding terminal of a corresponding electrical connector (not shown) and/or the first electrical contact 14.

The second connection region 60 may engage a corresponding terminal of a corresponding electrical connector (not shown) and/or the second electrical contact 16.

The second compliant region 62 may include a second set of apertures 76. The second set of apertures 76 may extend through the second plate 30. In some implementations, the second set of apertures 76 includes five apertures 76. Each aperture of the second set of apertures 76 may be stadium-shaped (e.g., a rectangle with semicircles at a pair of opposite sides). The apertures 76 could also be any other shape within the scope of the present disclosure. In some implementations, the second set of apertures 76 is equally-spaced across the second compliant region 62.

The second set of apertures 76 may allow the second contact region 58 to flex (e.g., bend) relative to the second connection region 60. In this regard, the second set of apertures 76 may reduce the stiffness of the second compliant region 62 relative to the other portions of the terminal 12 (e.g., the second contact region 58, the second connection region 60, etc.). In some implementations, the stiffness of the second compliant region 62 is less than the stiffness of a corresponding terminal (not shown) that the terminal 12 mates with.

In some implementations, each aperture of the second set of apertures 76 is aligned with a corresponding aperture of the first set of apertures 56. In this regard, the first set of apertures 56 and the second set of apertures 76 collectively extend through the first plate 28 and the second plate 30. In some implementations, each aperture of the second set of apertures 76 is offset from a corresponding aperture of the first set of apertures 56, such that the first set of apertures 56 and the second set of apertures 76 do not collectively extend through the first plate 28 and the second plate 30.

The third plate 32 may include a third contact region 78, a third connection region 80, and a third compliant region 82. The third compliant region 82 may be disposed between the third contact region 78 and the third connection region 80. In this regard, the third contact region 78 may be disposed proximate a first end 84 of the third plate 32 and the third connection region 80 may be disposed proximate a second end 86 of the third plate 32.

The third contact region 78 may engage a corresponding terminal of a corresponding electrical connector (not shown) and/or the first electrical contact 14. The third connection region 80 may engage a corresponding terminal of a corresponding electrical connector (not shown) and/or the second electrical contact 16.

The third compliant region 82 may include a third set of apertures 88. The third set of apertures 88 may extend through the third plate 32. In some implementations, the third set of apertures 88 includes five apertures 88. Each aperture of the third set of apertures 88 may be stadium-shaped (e.g., a rectangle with semicircles at a pair of opposite sides). The apertures 88 could also be any other shape within the scope of the present disclosure. In some implementations, the third set of apertures 88 is equally-spaced across the third compliant region 82.

The third set of apertures 88 may allow the third contact region 78 to flex (e.g., bend) relative to the third connection region 80. In this regard, the third set of apertures 88 may reduce the stiffness of the third compliant region 82 relative to the other portions of the terminal 12 (e.g., the third contact region 78, the third connection region 80, etc.). In some implementations, the stiffness of the third compliant region 82 is less than the stiffness of a corresponding terminal (not shown) that the terminal 12 mates with.

In some implementations, each aperture of the third set of apertures 88 is aligned with a corresponding aperture of the first set of apertures 56 and the second set of apertures 76. In this regard, the first set of apertures 56, the second set of apertures 76, and the third set of apertures collectively extend through the first plate 28, the second plate 30, and the third plate 32. In some implementations, each aperture of the third set of apertures 88 is aligned with a corresponding aperture of the first set of apertures 56 and offset from a corresponding aperture of the second set of apertures 76, such that the first set of apertures 56, the second set of apertures 76, and the third set of apertures 88 do not collectively extend through the first plate 28, the second plate 30, and the third plate 32.

The fourth plate 34 may include a fourth contact region 90, a fourth connection region 92, and a fourth compliant region 94. The fourth compliant region 94 may be disposed between the fourth contact region 90 and the fourth connection region 92. In this regard, the fourth contact region 90 may be disposed proximate a first end 96 of the fourth plate 34 and the fourth connection region 92 may be disposed proximate a second end 98 of the fourth plate 34.

The fourth contact region 90 may engage a corresponding terminal of a corresponding electrical connector (not shown) and/or the first electrical contact 14. The fourth connection region 92 may engage a corresponding terminal of a corresponding electrical connector (not shown) and/or the second electrical contact 16.

The fourth compliant region 94 may include a fourth set of apertures 100. The fourth set of apertures 100 may extend through the fourth plate 34. In some implementations, the fourth set of apertures 100 includes five apertures 100. Each aperture of the fourth set of apertures 100 may be stadium-shaped (e.g., a rectangle with semicircles at a pair of opposite sides). The apertures 100 could also be any other shape within the scope of the present disclosure. In some implementations, the fourth set of apertures 100 is equally-spaced across the fourth compliant region 94.

The fourth set of apertures 100 may allow the fourth contact region 90 to flex (e.g., bend) relative to the fourth connection region 92. In this regard, the fourth set of apertures 100 may reduce the stiffness of the fourth compliant region 94 relative to the other portions of the terminal 12 (e.g., the fourth contact region 90, the fourth connection region 92, etc.). In some implementations, the stiffness of the fourth compliant region 94 is less than the stiffness of a corresponding terminal (not shown) that the terminal 12 mates with.

In some implementations, each aperture of the fourth set of apertures 100 is aligned with a corresponding aperture of the first set of apertures 56, the second set of apertures 76, and the third set of apertures 88. In this regard, the first set of apertures 56, the second set of apertures 76, the third set of apertures 88, and the fourth set of apertures 100 collectively extend through the first plate 28, the second plate 30, the third plate 32, and the fourth plate 34 (e.g., through the terminal 12). In some implementations, each aperture of the fourth set of apertures 100 is aligned with a corresponding aperture of the second set of apertures 76 and offset from a corresponding aperture of the first set of apertures 56 and the third set of apertures 88, such that the first set of apertures 56, the second set of apertures 76, the third set of apertures 88, and the fourth set of apertures 100 do not collectively extend through the first plate 28, the second plate 30, the third plate 32, and the fourth plate 34.

In some implementations, the terminal 12 includes a return spring 102. The return spring 102 may be disposed between the second plate 30 and the third plate 32. The return spring 102 may engage at least one of the one or more flexible arms 46 and/or at least one of the one or more flexible arms 68. In this regard, the return spring 102 may have a profile that mirrors a profile of the one or more flexible arms 46 and/or the one or more flexible arms 68. A combined stiffness of the return spring 102 and the one or more flexible arms 46 and/or the one or more flexible arms 68 may be less than the stiffness of a corresponding terminal (not shown) that mates with the terminal 12. This may allow at least one of the one or more rigid contacts 47 to remain in contact with the corresponding terminal (not shown) that mates with the terminal 12.

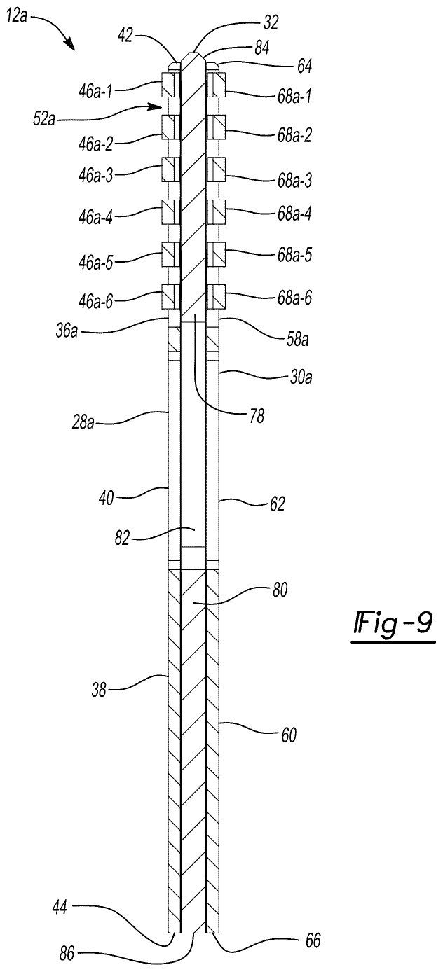

Referring now to FIGS. 8 and 9, a terminal 12a is shown. In view of the substantial similarity in structure and function of the components associated with the terminal 12a with respect to the terminal 12, like reference numerals are used hereinafter, and in the drawings, to identify like components while like reference numerals containing letter extensions (e.g., “a”) are used to identify those components that have been modified. Any references herein to the terminal 12, or any component thereof, will be understood to apply equally to the terminal 12a, or the corresponding component thereof, unless otherwise noted.

The terminal 12a may include a first plate 28a, a second plate 30a, and the third plate 32. The third plate 32 may be disposed between the first plate 28a and the second plate 30a.

The first plate 28a may include a first contact region 36a, the first connection region 38, and the first compliant region 40. The first compliant region 40 may be disposed between the first contact region 36a and the first connection region 38. In this regard, the first contact region 36a may be disposed proximate the first end 42 of the first plate 28a and the first connection region 38 may be disposed proximate the second end 44 of the first plate 28a.

The first contact region 36a may include one or more flexible arms 46a and the opening 48. The one or more flexible arms 46a may extend across the opening 48. For example, the one or more flexible arms 46a may include a first flexible arm 46a-1 and a second flexible arm 46a-2 extending from the first edge 50 to the second edge 54 of the opening 48. The first flexible arm 46a-1 and the second flexible arm 46a-2 may at least partially define a gap 52a therebetween. In some implementations, the first contact region 36a further includes a third flexible arm 46a-3, a fourth flexible arm 46a-4, a fifth flexible arm 46a-5, and a sixth flexible arm 46a-6 extending from the first edge 50 to the second edge 54 of the opening 48. The one or more flexible arms 46a may flex (e.g., bend) upon coming into contact with a corresponding terminal of a corresponding electrical connector (not shown) and/or the first electrical contact 14.

The second plate 30a may include a second contact region 58a, the second connection region 60, and the second compliant region 62. The second compliant region 62 may be disposed between the second contact region 58a and the second connection region 60. In this regard, the second contact region 58a may be disposed proximate the first end 64 of the second plate 30a and the second connection region 60 may be disposed proximate the second end 66 of the second plate 30a.

The second contact region 58a may include one or more flexible arms 68a and the opening 70. The one or more flexible arms 68a may extend across the opening 70. For example, the one or more flexible arms 68a may include a first flexible arm 68a-1 and a second flexible arm 68-2 extending from the first edge 72 to the second edge 74 of the opening 70. In some implementations, the second contact region 58a further includes a third flexible arm 68a-3, a fourth flexible arm 68a-4, a fifth flexible arm 68a-5, and a sixth flexible arm 68a-6 extending from the first edge 72 to the second edge 74 of the opening 70. The one or more flexible arms 68a may flex (e.g., bend) upon coming into contact with a corresponding terminal of a corresponding electrical connector (not shown) and/or the first electrical contact 14.

In some implementations, each aperture of the third set of apertures 88 is aligned with a corresponding aperture of the first set of apertures 56 and the second set of apertures 76. In this regard, the first set of apertures 56, the second set of apertures 76, and the third set of apertures collectively extend through the first plate 28a, the second plate 30a, and the third plate 32. In some implementations, each aperture of the third set of apertures 88 is aligned with a corresponding aperture of the first set of apertures 56 and offset from a corresponding aperture of the second set of apertures 76, such that the first set of apertures 56, the second set of apertures 76, and the third set of apertures 88 do not collectively extend through the first plate 28a, the second plate 30a, and the third plate 32.

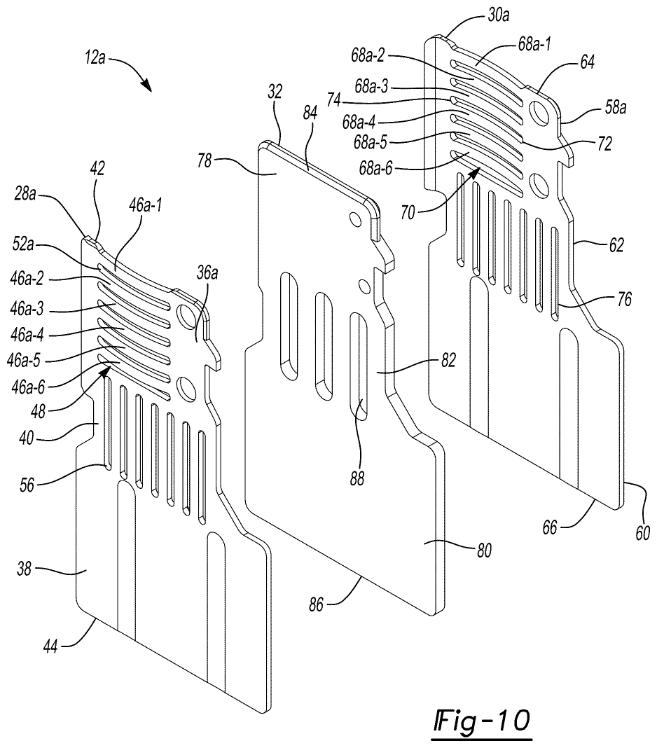

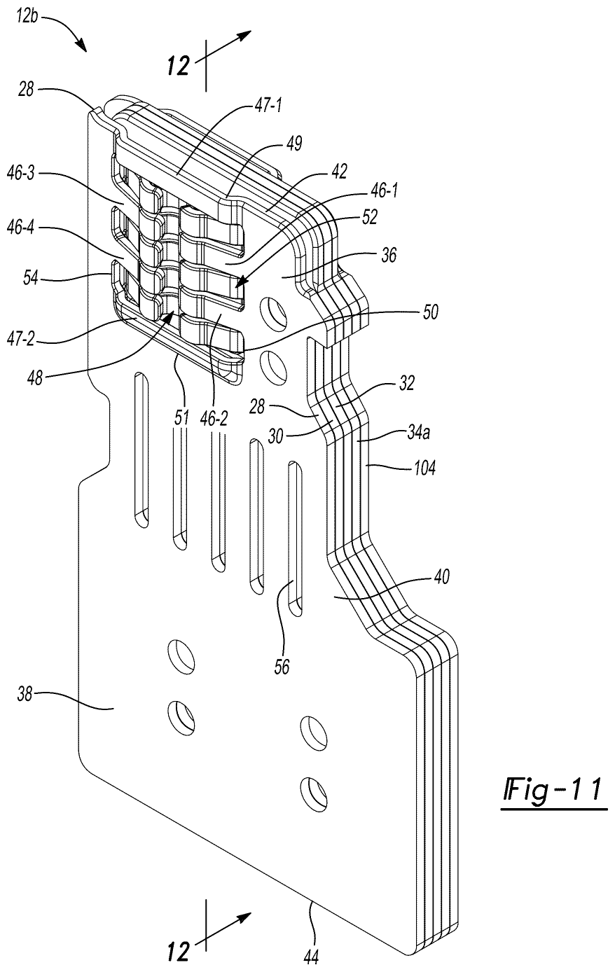

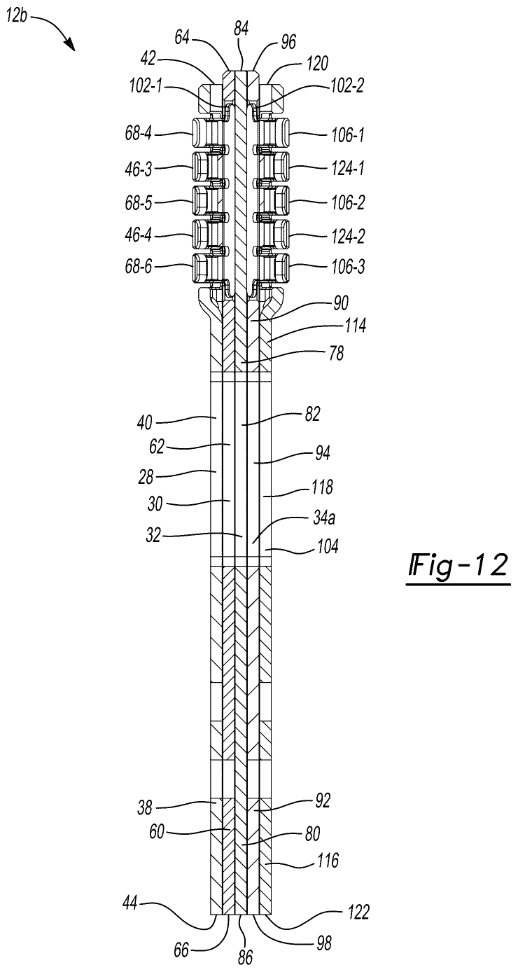

Referring now to FIGS. 10-12, a terminal 12b is shown. In view of the substantial similarity in structure and function of the components associated with the terminal 12b with respect to the terminal 12, 12a, like reference numerals are used hereinafter, and in the drawings, to identify like components while like reference numerals containing letter extensions (e.g., “b”) are used to identify those components that have been modified. Any references herein to the terminal 12, 12a, or any component thereof, will be understood to apply equally to the terminal 12b, or the corresponding component thereof, unless otherwise noted.

The terminal 12b may include the first plate 28, the second plate 30, the third plate 32, a fourth plate 34b, and a fifth plate 104. The third plate 32 may be disposed between the second plate 30 and the fourth plate 34b. The second plate 30 may be disposed between the first plate 28 and the third plate 32. The fourth plate 34b may be disposed between the third plate 32 and the fifth plate 104.

The fourth plate 34b may include a fourth contact region 90b, the fourth connection region 92, and the fourth compliant region 94. The fourth compliant region 94 may be disposed between the fourth contact region 90b and the fourth connection region 92. In this regard, the fourth contact region 90b may be disposed proximate the first end 96 of the fourth plate 34b and the fourth connection region 92 may be disposed proximate the second end 98 of the fourth plate 34b.

The fourth contact region 90b may include one or more flexible arms 106, one or more rigid contacts 107, and an opening 108. The one or more flexible arms 106 may extend from one or more edges of the opening 108 towards a center of the opening 108. For example, the one or more flexible arms 106 may include a first flexible arm 106-1, a second flexible arm 106-2, and a third flexible arm 106-3 extending from a first edge 110 of the opening 108.

In some implementations, the fourth contact region 90b further includes a fourth flexible arm 106-4, a fifth flexible arm 106-5, and a sixth flexible arm 106-6 extending from a second edge 112 of the opening 108. The second edge 112 may be opposite the first edge 110. The one or more flexible arms 106 may flex (e.g., bend) upon coming into contact with a corresponding terminal of a corresponding electrical connector (not shown) and/or the first electrical contact 14.

The fifth plate 104 may include a fifth contact region 114, a fifth connection region 116, and a fifth compliant region 118. The fifth compliant region 118 may be disposed between the fifth contact region 114 and the fifth connection region 116. In this regard, the fifth contact region 114 may be disposed proximate a first end 120 of the fifth plate 104 and the fifth connection region 116 may be disposed proximate a second end 122 of the fifth plate 104.

The fifth contact region 114 may include one or more flexible arms 124, one or more rigid contacts 125, and an opening 126. The one or more flexible arms 124 may extend from one or more edges of the opening 126 towards a center of the opening 126. For example, the one or more flexible arms 124 may include a first flexible arm 124-1 and a second flexible arm 124-2 extending from a first edge 128 of the opening 126. The first flexible arm 124-1 and the second flexible arm 124-2 may at least partially define a gap 130 therebetween. When the terminal 12b is assembled, the first flexible arm 106-1, the second flexible arm 106-2, the third flexible arm 106-3, the first flexible arm 124-1, and the second flexible arm 124-2 may be arranged in an alternating fashion. In this regard, the second flexible arm 106-2 may be disposed in the gap 130 between the first flexible arm 124-1 and the second flexible arm 124-2.

In some implementations, the fifth contact region 114 further includes a third flexible arm 124-3 and a fourth flexible arm 124-4 extending from a second edge 132 of the opening 126. The third flexible arm 124-3 may extend towards the first flexible arm 124-1 and the fourth flexible arm 124-4 may extend towards the second flexible arm 124-2. The second edge 132 may be opposite the first edge 128. The one or more flexible arms 124 may flex (e.g., bend) upon coming into contact with a corresponding terminal of a corresponding electrical connector (not shown) and/or the first electrical contact 14.

The one or more rigid contacts 125 may engage a corresponding terminal of a corresponding electrical connector (not shown) and/or the first electrical contact 14. The one or more rigid contacts 125 may include a first rigid contact 125-1 and a second rigid contact 125-2. The first rigid contact 125-1 may extend from a third side 127 of the opening 126 and the second rigid contact 125-2 may extend from a fourth side 129 of the opening 126.

The fifth connection region 116 may engage a corresponding terminal of a corresponding electrical connector (not shown) and/or the second electrical contact 16.

The fifth compliant region 118 may include a fifth set of apertures 134. One or more apertures of the fifth set of apertures 134 may extend through the fifth plate 104. In some implementations, the fifth set of apertures 134 includes five apertures 56. Each aperture of the fifth set of apertures 134 may be stadium-shaped (e.g., a rectangle with semicircles at a pair of opposite sides). The apertures 134 could also be any other shape within the scope of the present disclosure. In some implementations, the fifth set of apertures 134 is equally-spaced across the fifth compliant region 118.

The fifth set of apertures 134 may allow the fifth contact region 114 to flex (e.g., bend) relative to the fifth connection region 116. In this regard, the fifth set of apertures 134 may reduce the stiffness of the fifth compliant region 118 relative to the other portions of the terminal 12b (e.g., the fifth contact region 114, the fifth connection region 116, etc.). In some implementations, the stiffness of the fifth compliant region 118 is less than the stiffness of a corresponding terminal (not shown) that the terminal 12b mates with.

In some implementations, each aperture of the fifth set of apertures 134 is aligned with a corresponding aperture of the first set of apertures 56, the second set of apertures 76, the third set of apertures 88, and the fourth set of apertures 100. In this regard, the first set of apertures 56, the second set of apertures 76, the third set of apertures 88, the fourth set of apertures 100, and the fifth set of apertures 134 collectively extend through the first plate 28, the second plate 30, the third plate 32, the fourth plate 34b, and the fifth plate 104 (e.g., through the terminal 12b). In some implementations, each aperture of the fifth set of apertures 134 is aligned with a corresponding aperture of the first set of apertures 56 and the third set of apertures 88 and offset from a corresponding aperture of the second set of apertures 76 and the fourth set of apertures 100, such that the first set of apertures 56, the second set of apertures 76, the third set of apertures 88, the fourth set of apertures 100, and the fifth set of apertures do not collectively extend through the first plate 28, the second plate 30, the third plate 32, the fourth plate 34b, and the fifth plate 104.

In some implementations, the terminal 12b includes a first return spring 102-1 and a second return spring 102-2. The first return spring 102-1 may be disposed between the second plate 30 and the third plate 32. The second return spring 102-2 may be disposed between the third plate 32 and the fourth plate 34b.

The first return spring 102-1 may engage at least one of the one or more flexible arms 46 and/or at least one of the one or more flexible arms 68. In this regard, the first return spring 102-1 may have a profile that mirrors a profile of the one or more flexible arms 46 and/or the one or more flexible arms 68. The second return spring 102-2 may engage at least one of the one or more flexible arms 106 and/or at least one of the one or more flexible arms 124. In this regard, the second return spring 102-2 may have a profile that mirrors a profile of the one or more flexible arms 106 and/or the one or more flexible arms 124. A combined stiffness of the first return spring 102-1, the second return spring 102-2, the one or more flexible arms 46, the one or more flexible arms 68, the one or more flexible arms 106, and/or the one or more flexible arms 124 may be less than the stiffness of a corresponding terminal (not shown) that the terminal 12b mates with. This may allow at least one of the one or more rigid contacts 47 and/or the one or more rigid contacts 125 to remain in contact with the corresponding terminal (not shown) that the terminal 12b mates with.

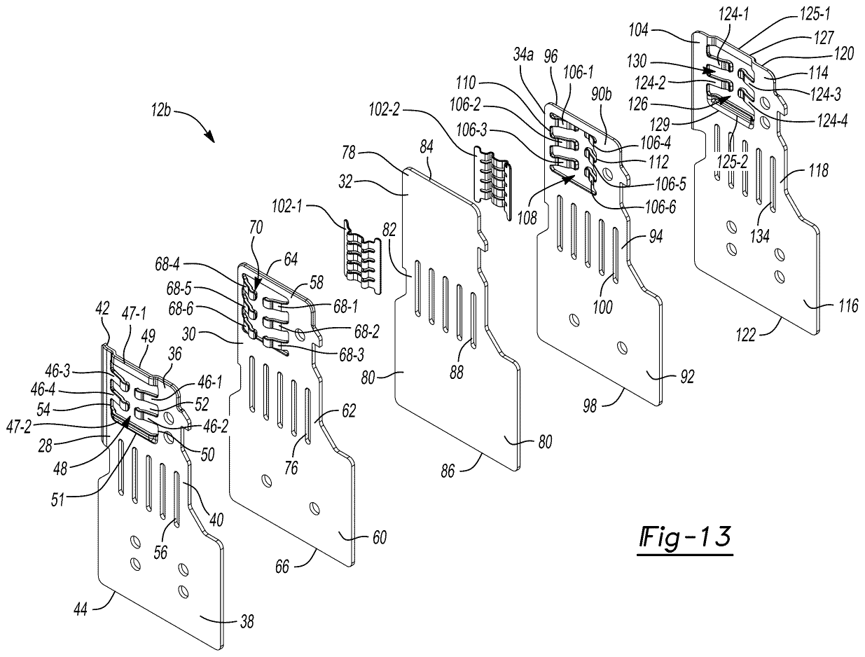

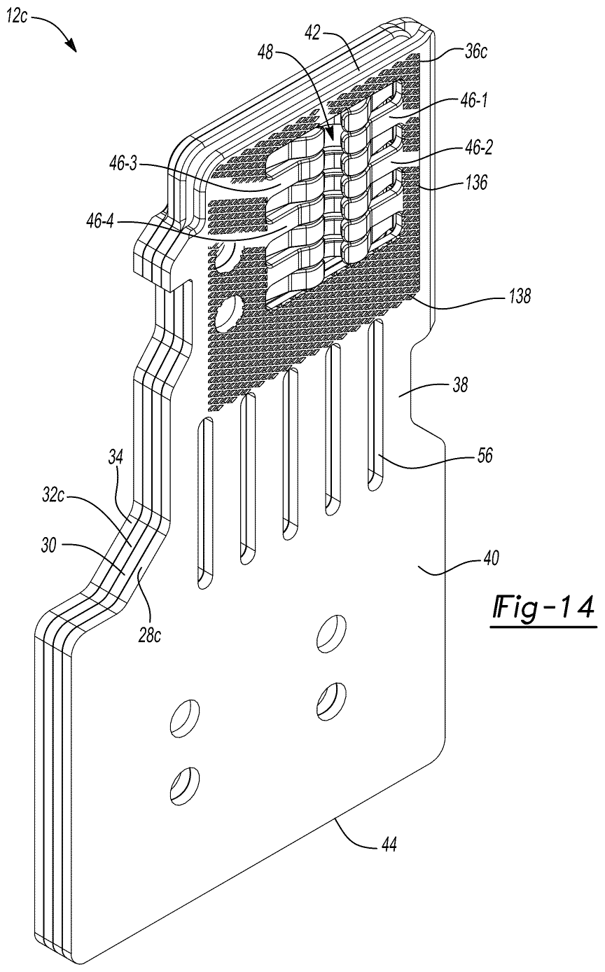

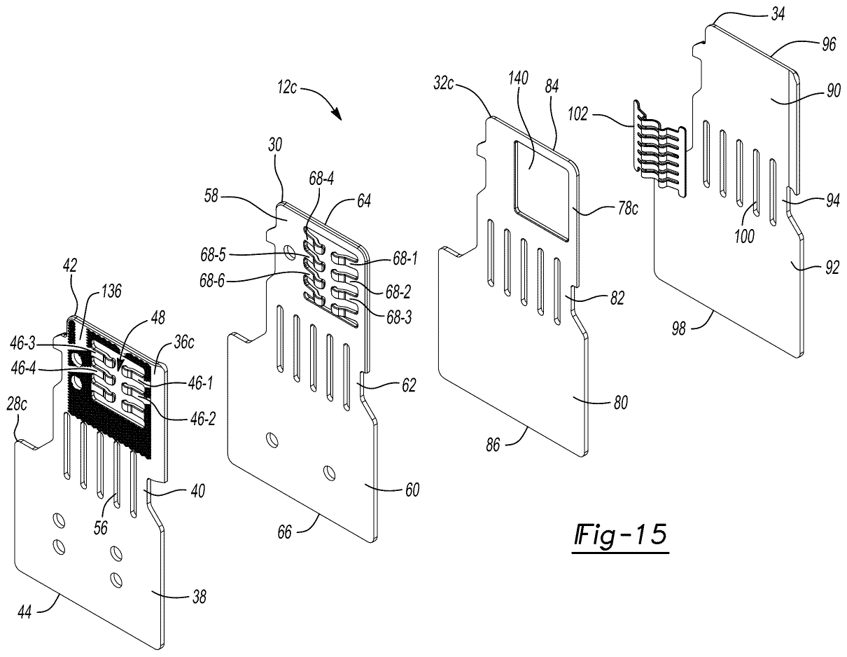

Referring now to FIGS. 13 and 14, a terminal 12c is shown. In view of the substantial similarity in structure and function of the components associated with the terminal 12c with respect to the terminal 12, 12a, 12b like reference numerals are used hereinafter, and in the drawings, to identify like components while like reference numerals containing letter extensions (e.g., “c”) are used to identify those components that have been modified. Any references herein to the terminal 12, 12a, 12b, or any component thereof, will be understood to apply equally to the terminal 12c, or the corresponding component thereof, unless otherwise noted.

The terminal 12c may include a first plate 28c, the second plate 30, a third plate 32c, and the fourth plate 34. The second plate 30 may be disposed between the first plate 28c and the third plate 32c. The third plate 32c may be disposed between the second plate 30 and the fourth plate 34.

The first plate 28c may include a first contact region 36c, the first connection region 38, and the first compliant region 40. The first compliant region 40 may be disposed between the first contact region 36c and the first connection region 38. In this regard, the first contact region 36c may be disposed proximate the first end 42 of the first plate 28c and the first connection region 38 may be disposed proximate the second end 44 of the first plate 28c.

The first contact region 36c may include the one or more flexible arms 46, the opening 48, and a textured region 136. The textured region 136 may surround the opening 48. The textured region 136 may at least partially cover the first contact region 36c. In some implementations, the textured region 136 completely covers the first contact region 36c.

In some implementations, the textured region 136 includes a plurality of protrusions 138. In some implementations, the textured region 136 is formed by a knurling process. In some implementations, the textured region 136 (e.g., the plurality of protrusions 138) prevents the first plate 28c from deforming (e.g., bending, cupping, etc.) when the first plate 28c comes into contact with a corresponding terminal of a corresponding electrical connector (not shown) and/or the first electrical contact 14. This allows the first contact region 36 to remain in contact with the corresponding electrical connector (not shown) and/or the first electrical contact 14. In this regard, the textured region may functionally replace the one or more rigid contacts 47, 125.

The third plate 32c may include a third contact region 78c, the third connection region 80, and the third compliant region 82. The third compliant region 82 may be disposed between the third contact region 78c and the third connection region 80. In this regard, the third contact region 78c may be disposed proximate the first end 84 of the third plate 32c and the third connection region 80 may be disposed proximate the second end 86 of the third plate 32c. The third contact region 78c may include an opening 140. In an assembled configuration, the return spring 102 may be disposed in the opening 140.

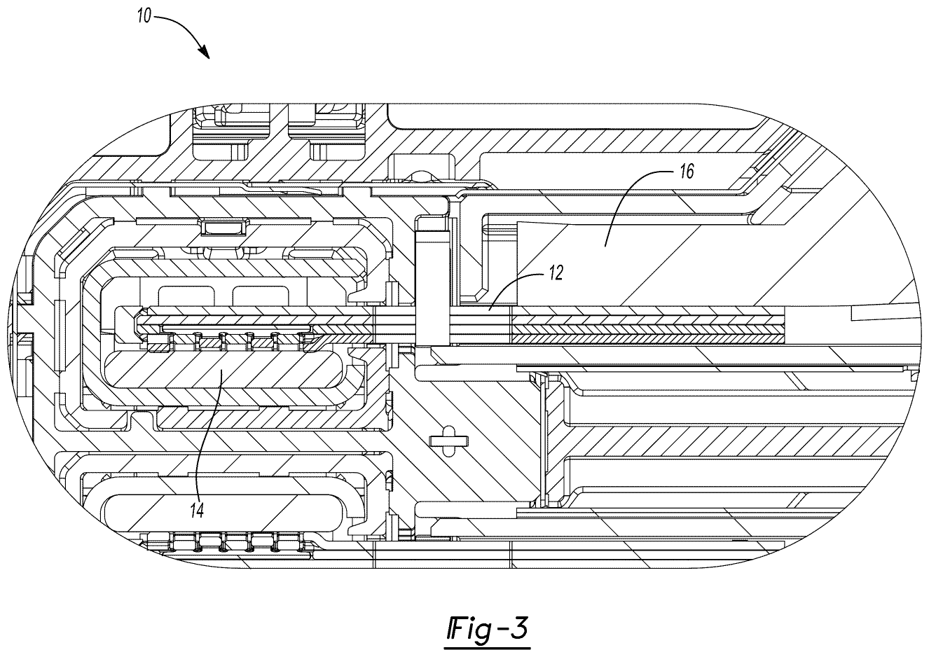

In a high electrical current application, for example, where a cross-sectional area (e.g., FIGS. 3 and/or 6) of the terminal has been increased to accommodate the current without a corresponding increase in heat, the configuration (e.g., the contact region, the connection region, and/or the compliant region) of the terminal (e.g., terminal 12, 12a, 12b, 12c) may allow the terminal to flex and, thereby, ensure that, mating of the connector 10 with a corresponding connector, and applying a force on the terminal with the first electrical contact 14 and/or the second electrical contact 16, does not disengage the terminal 12 from the other of the first electrical contact 14 and/or the second electrical contact 16.

Various example embodiments of the invention are described in the following clauses.

Clause 1: A terminal comprising: a first contact region including a first flexible arm; a first connection region; and a first compliant region disposed between the first contact region and the first connection region and defining a first aperture.

Clause 2: The terminal of clause 1, wherein the first contact region includes a second flexible arm offset from the first flexible arm.

Clause 3: The terminal of any of clauses 1 or 2, further comprising a first plate, wherein at least one of the first contact region, the first connection region, or the first compliant region are disposed on the first plate.

Clause 4: The terminal of clause 3, wherein the first contact region, the first connection region, and the first compliant region are disposed on the first plate.

Clause 5: The terminal of any of clauses 3 or 4, further comprising a second plate coupled to the first plate, the second plate including a second contact region, a second connection region, and a second compliant region disposed between the second contact region and the second connection region, the second compliant region defining a second aperture.

Clause 6: The terminal of clause 5, wherein the first aperture is aligned with the second aperture.

Clause 7: The terminal of any of clauses 5 or 6, further comprising a third plate coupled to the second plate, the third plate including a third contact region, a third connection region, and a third compliant region disposed between the third contact region and the third connection region, the third compliant region defining a third aperture.

Clause 8: The terminal of clause 7, wherein the third aperture is offset from the first aperture and the second aperture.

Clause 9: The terminal of any of clauses 7 or 8, further comprising a fourth plate coupled to the third plate, the fourth plate including a fourth contact region, a fourth connection region, and a fourth compliant region disposed between the fourth contact region and the fourth connection region and defining a fourth aperture.

Clause 10: The terminal of clause 9, further comprising a fifth plate coupled to the fourth plate, the fifth plate including a fifth contact region, a fifth connection region, and a fifth compliant region disposed between the fifth contact region and the fifth connection region and defining a fifth aperture.

Clause 11: The terminal of any of clauses 5 through 10, wherein the second contact region includes a third flexible arm.

Clause 12: The terminal of any of clauses 5 through 11, further comprising a first return spring disposed between the first plate and the second plate, the first return spring configured to engage the first flexible arm.

Clause 13: The terminal of clause 12, wherein the first return spring engages the second plate.

Clause 14: A connector comprising: the terminal of any of clauses 1 through 13; and a main body portion, wherein the terminal is disposed within the main body portion.

Clause 15: The connector of clause 14, further comprising a first electrical contact coupled to the first contact region and a second electrical contact coupled to the first connection region.

Clause 16: A busbar comprising: a first contact region; a first connection region; and a first compliant region disposed between the first contact region and the first connection region and defining a first aperture configured to allow the busbar to flex between the first contact region and the first connection region.

Clause 17: The busbar of clause 16, wherein the first contact region includes a first flexible arm.

Clause 18: The busbar of clauses 16 or 17, wherein at least one of the first contact region, the first connection region, or the first compliant region are disposed on a first plate.

Clause 19: The busbar of any of clauses 16 through 18, wherein the first contact region, the first connection region, and the first compliant region are disposed on the first plate.

Clause 20: The busbar of any of clauses 16 through 19, further comprising a second plate coupled to the first plate, the second plate including a second contact region, a second connection region, and a second compliant region disposed between the second contact region and the second connection region, the second compliant region defining a second aperture.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (“between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A terminal comprising:
a first contact region including a first flexible arm;
a first connection region; and
a first compliant region disposed between the first contact region and the first connection region and defining a first aperture.

2. The terminal of claim 1, wherein the first contact region includes a second flexible arm offset from the first flexible arm.

3. The terminal of claim 1, further comprising a first plate, wherein at least one of the first contact region, the first connection region, or the first compliant region are disposed on the first plate.

4. The terminal of claim 3, wherein the first contact region, the first connection region, and the first compliant region are disposed on the first plate.

5. The terminal of claim 3, further comprising a second plate coupled to the first plate, the second plate including a second contact region, a second connection region, and a second compliant region disposed between the second contact region and the second connection region, the second compliant region defining a second aperture.

6. The terminal of claim 5, wherein the first aperture is aligned with the second aperture.

7. The terminal of claim 5, further comprising a third plate coupled to the second plate, the third plate including a third contact region, a third connection region, and a third compliant region disposed between the third contact region and the third connection region, the third compliant region defining a third aperture.

8. The terminal of claim 7, wherein the third aperture is offset from the first aperture and the second aperture.

9. The terminal of claim 7, further comprising a fourth plate coupled to the third plate, the fourth plate including a fourth contact region, a fourth connection region, and a fourth compliant region disposed between the fourth contact region and the fourth connection region and defining a fourth aperture.

10. The terminal of claim 9, further comprising a fifth plate coupled to the fourth plate, the fifth plate including a fifth contact region, a fifth connection region, and a fifth compliant region disposed between the fifth contact region and the fifth connection region and defining a fifth aperture.

11. The terminal of claim 5, wherein the second contact region includes a third flexible arm.

12. The terminal of claim 5, further comprising a first return spring disposed between the first plate and the second plate, the first return spring configured to engage the first flexible arm.

13. The terminal of claim 12, wherein the first return spring engages the second plate.

14. A connector comprising:
the terminal of claim 1; and
a main body portion, wherein the terminal is disposed within the main body portion.

15. The connector of claim 14, further comprising a first electrical contact coupled to the first contact region and a second electrical contact coupled to the first connection region.

16. A busbar comprising:
a first contact region;
a first connection region; and
a first compliant region disposed between the first contact region and the first connection region and defining a first aperture configured to allow the busbar to flex between the first contact region and the first connection region.

17. The busbar of claim 16, wherein the first contact region includes a first flexible arm.

18. The busbar of claim 17, wherein at least one of the first contact region, the first connection region, or the first compliant region are disposed on a first plate.

19. The busbar of claim 18, wherein the first contact region, the first connection region, and the first compliant region are disposed on the first plate.

20. The busbar of claim 19, further comprising a second plate coupled to the first plate, the second plate including a second contact region, a second connection region, and a second compliant region disposed between the second contact region and the second connection region, the second compliant region defining a second aperture.
